(19) United States
(12) Patent Application Publication
(10) Pub. No.: US 2005/0014407 A1
(43) Pub. Date: Jan. 20, 2005

(54) Plug connector position control for checking the complete and proper execution of an electrical plug connection between a plug connector and a mating connector

(76) Inventors: Martin Saur, Salach (DE); Achim Puettner, Hofen (DE); Michael Schoenfeld, Leinfelden-Echterdingen (DE); Andreas Simmel, Schwaikheim (DE); Sabine Allgeier, Fellbach-Schmiden (DE); Mohammed Lamdiziz, Remseck/Pattonville (DE); Markus Todesco, Schorndorf (DE); Hans Kurt Allgeier, Karlsruhe (DE)

Correspondence Address: KENYON & KENYON, ONE BROADWAY, NEW YORK, NY, 10004, US

(21) Appl. No.: 10/746,410

(22) Filed: Dec. 23, 2003

(30) Foreign Application Priority Data
Dec. 24, 2002 (DE) 10261017.7

(51) Int. Cl. H01R 29/00

(52) U.S. Cl. 439/189

(57) ABSTRACT

A plug connector position control element for checking the complete and proper execution of an electrical plug connection between a plug having a locking mechanism and a mating connector, which is constantly demonstrable at a remote location, as to whether the electrical plug connection is properly plugged in. A triggering element actuates a sensor element depending upon a properly executed plug connection.

### FIELD OF THE INVENTION

The present invention relates to a plug connector position control element for checking the complete and proper execution of an electrical plug connection between a plug having a locking mechanism element and a mating connector.

### BACKGROUND INFORMATION

Various designs of plug connector position control elements are known from the related art. They are used to give an acknowledgment to the user, who is to bring about an electrical plug connection between a plug and a mating connector, that the plug connection has been carried out completely and properly. As a rule, these acknowledgment elements are to be operated by a separate work step, and must not independently reach their end position during the plugging procedure.

Immediately after the acknowledgment element reaches the end position, the person doing the plugging receives a tactile and/or optical report as to whether the plug connection has been executed properly.

The named related art has the shortcoming that the proper plugging of an electrical plug connection using a mechanical acknowledgment is only able to be checked during the plugging procedure itself, or subsequently by a targeted assessment of the respective plug connection. A constant checking of the correct seating of electrical plug connections during operation, such as in non-stationary applications, is not possible using these designs that are known from the related art.

### SUMMARY OF THE INVENTION

An object of the present invention is to avoid the disadvantages of the related art.

The core of the attainment of the object is actuating a sensor element by using a triggering element upon the complete and proper execution of the electrical plug connection, the sensor element, in turn, actuating a signaling device which emits an appropriate signal for control to the person doing the plugging.

One of the important advantages of the present invention is that constant checking of the proper seating of the electrical plug connection is possible during operation.

Putting it into use is done by generating an electrical signal, as soon as the plug connection is properly plugged in. This signal is constantly conducted further via, for instance, the wiring harness of a vehicle, to an interpreting location such as an indicator lamp, central computer, etc, and may consequently be queried during operation without a person's having to take mechanical or optical control.

In particular, for the signal generation, triggering elements and sensor elements may be mounted in different locations:

plug position control on the housing of the plug and the mating connector

plug position control element on the locking mechanism and the housing of the mating connector

plug position control element on the locking mechanism and the housing of the plug

The design of the triggering element and the sensor element may also vary greatly. Thus, for example, the triggering element may be a pin which bridges an electrical bridge that is designed as a sensor element. There may further be provided a microswitch which is operated by a component of the plug connection or the housing of the plug. An alternative to this is provided in the construction of a reed contact which is operated with the aid of a magnet that is located in a component of the plug connection (or the plug or the mating connector). A further alternative specific embodiment would be to use a proximity switch which has either an inductive or a capacitive design, and is operated by a suitable element that is located in a component of the plug connection.

What is important is that the proper function of the electrical plug position control should be designed in such a way that, by a suitably constructed design, the signal is generated only at the last moment of the plugging procedure, since only then can the proper plugging of the plug connection be ensured.

### BRIEF DESCRIPTION OF THE DRAWINGS

FIG. 1 shows a first exemplary embodiment of a plug position control in an electrical plug connection in the non-triggered state.

FIG. 2 shows a first exemplary embodiment of a plug position control in a plugged electrical plug connection in the triggered state.

### DETAILED DESCRIPTION

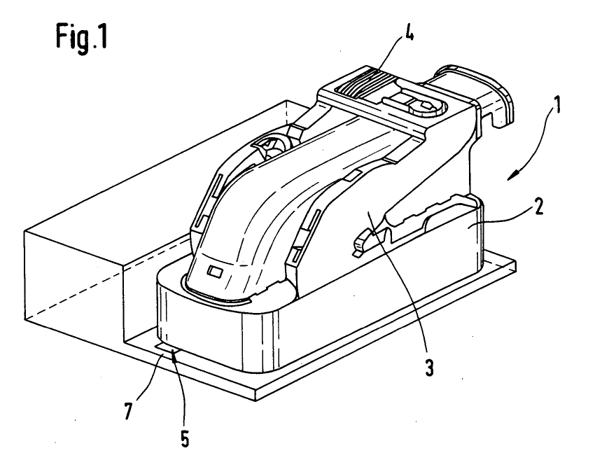

FIG. 1 shows a partially plugged in electrical plug connection 1 having a housing 2. Electrical plug connection 1 further includes a locking mechanism 3 and an optional mechanical plug position control 4. The plug connection also has a triggering element 5, which is situated on plug housing 2.

In the exemplary embodiment shown here in FIG. 1, the mating connector is designed as a so-called interface housing 6. This interface housing 6 has, among other things, a sensor element 7.

When the plug connection has not been completely plugged in, sensor element 7 is not actuated.

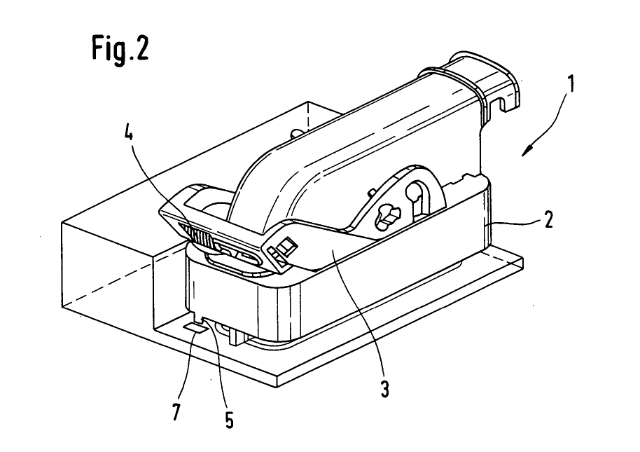

By contrast, in FIG. 2, plug connection 1 known from FIG. 1 is shown in the completely plugged in state. In this state, triggering element 5 actuates sensor element 7. By this actuation, an electrical signal is generated, which is triggered, for example, via a signal device which is not shown more closely in the drawings.

By interpreting this signal, for example, using an indicator lamp or by passing it on to a central computer, an electrical plug position control is made possible, that is, at a location which is at a distance from the plug connection, it is constantly demonstrable whether the electrical plug connection is plugged in properly or not.

1. A plug connector position control element for checking a complete and proper execution of an electrical plug connection between a plug having a locking mechanism and a mating connector, the plug connector position control element comprising:
a triggering element for actuating a sensor element in a properly plugged-in state of the electrical plug connection; and
a signal device for emitting a signal upon the actuation of the sensor element.

2. The plug connector position control element according to claim 1, wherein the triggering element is a contact element and the sensor element forms an electrical bridge in response to a properly plugged-in state.

3. The plug connector position control element according to claim 1, wherein the sensor element includes a microswitch which is triggered by a properly established plug connection.

4. The plug connector position control element according to claim 1, wherein the sensor element includes a reed contact which is triggered by a magnet situated on the plug connection.

5. The plug connector position control element according to claim 1, wherein the sensor element includes a proximity switch, which is one of inductive and capacitive.

6. The plug connector position control element according to claim 1, wherein the plug connector position control element is situated on a housing of the plug connection.

7. The plug connector position control element according to claim 1, wherein the plug connector position control element is situated on the locking mechanism and on a housing of the mating connector.

8. The plug connector position control element according to claim 1, wherein the plug connector position control element is situated on the locking mechanism and on a plug housing.

9. The plug connector position control element according to claim 1, wherein the mating connector includes an interface housing.
